(19) United States
(12) Patent Application Publication
(10) Pub. No.: US 2015/0053096 A1
(43) Pub. Date: Feb. 26, 2015

(54) BROILING RACK FOR A BARBECUE GRILL

(71) Applicants: Rafi Rafael NEHUSHTAN, Yahud (IL); Menashe KEHELA, Beit Dagan (IL)

(72) Inventors: Rafi Nehushtan, Yahud (IL); Menashe Kehela, Beit Dagan (IL)

(21) Appl. No.: 14/379,538

(22) PCT Filed: Feb. 20, 2013
(86) PCT No.: PCT/IL2013/050152

§ 371 Date: Aug. 19, 2014

Related U.S. Application Data
(60) Provisional application No. 61/601,047, filed on Feb. 21, 2012.

(51) Int. Cl. A47J 37/06

(52) U.S. Cl. CPC A47J 37/0694
USPC 99/445

(57) ABSTRACT

A broiling rack for draining grease drippings away from a heat source, including a multiplicity of upper-level lateral bars, a multiplicity of lower-level lateral bars, and two side walls. At least two rows of openings are formed in each of the side walls, wherein each end of the lateral bars is seated in a respective opening of the multiplicity of openings. An upper row of openings accommodates the upper-level lateral bars, and the lower row of openings accommodates the lower-level lateral bars. All of the lateral bars are substantially parallel to each other, wherein gaps are formed between adjacent lateral bars and wherein the upper-level lateral bars are wider than the lower level gaps that facilitate heat, generated by the heat source, to reach items placed on top of the up per-level lateral bars. Preferably, lateral bars are inclined towards at least one side wall.

### FIELD OF THE INVENTION

The present invention relates generally to cooking grid for barbecue grills, and more particularly, the invention relates to broiling rack for a barbecue grill facilitated to prevent grease drippings from falling on the heating source and thereby prevent smoke generation and burning of meats.

### BACKGROUND OF THE INVENTION AND PRIOR ART

When using various barbecue grills, having a heating source, such as open flame, electric heater, gas, charcoal briquettes or any other heating source, underneath the cooking grid, fatty meats tend to melt and drip down onto the heating source and thereby generating smoke as well as high flames that may burn the meats.

However, there is a need to provide a broiling rack facilitated to catch liquid drippings, such as grease drippings, during barbecuing by routing and collecting the cooking effluence during barbecuing, while allowing for the heat to flow freely towards the meats and allowing for the broiling rack to be situated in proximity to the heat source.

### SUMMARY OF THE INVENTION

The principal intentions of the present invention include providing a broiling rack for facilitated to collect liquid drippings, such as heated grease drippings (hereinafter refer to as “grease drippings”, with no limitation on any other type liquid drippings), including upper-level lateral bars, lower-level lateral bars and side walls. The upper-level lateral bars and the lower-level lateral bars are drainage canal that collect the grease and channel the grease out through the side walls.

Preferably, one or both side walls are the inner walls of a respective drainage trough, wherein the drainage trough further includes a floor and an outer wall. The grease flows from the lateral bars into the drainage trough, and drained therefrom.

According to the teachings of the present invention, there is provided a broiling rack for draining grease drippings away from the heat source, including a heat source, a multiplicity of upper-level lateral bars, a multiplicity of lower-level lateral bars, and two side walls. A multiplicity of openings is formed in each of the side walls, wherein each end of the lateral bars is seated in a respective opening of the multiplicity of openings.

Operatively, the upper row of openings, formed in each of the side walls, is configured to accommodate the upper-level lateral bars, are generally horizontal. The lower row of openings, formed in each of the side walls, is configured to accommodate the lower-level lateral bars.

All of the lateral bars are substantially parallel to each other, wherein the upper-level lateral bars are wider than γ_{low}, and wherein the lower-level lateral bars are wider than γᵤₚ. Gaps γᵤₚ are formed between adjacent upper-level lateral bars; and gaps γ_{low} are formed between adjacent lower-level lateral bars. The gaps facilitate heat, generated by the heat source, to reach items placed on top of the upper-level lateral bars.

From a bird's-eye view, the upper-level lateral bars conceal the gaps γ_{low} and partially overlap the lower-level lateral bars, such that for each of the gaps γᵤₚ, a respective lower-level lateral bar is disposed directly below the gaps γᵤₚ, and for each of the gaps γ_{low}, a respective upper-level lateral bar is disposed directly above the gaps γ_{low}.

Preferably, each of the upper-level lateral bars and the lower-level lateral bars is inclined towards at least one side wall, to thereby facilitating an improved drainage of the collected liquid grease and channel the collected grease away from the heat source, through the at least one side wall. Each level of lateral bars may be inclined towards a different side wall. Both levels of lateral bars may be inclined towards a selected side wall or may be inclined towards a both side walls.

Optionally, each of the two side walls is subdivided into two separate side walls, an upper-side-wall and a lower-side-wall. The upper-level lateral bars are respectively disposed in the openings formed in the upper-side-walls and the lower-level lateral bars are respectively disposed in the openings formed in the lower-side-walls.

Optionally, each of the two side walls is an inner wall of a trough, having a floor and an outer wall.

The lateral section profile of the lateral bars may be selected from a group of profiles including a V-shaped profile, an inverted-trapezoid-shaped profile, a U-shaped profile having a rounded floor and a U-shaped profile having a substantially flat floor.

Optionally, the bottom surface of one or more of the upper-level lateral bars is concave is concave.

Optionally, a groove is formed at the bottom surface of one or more of the upper-level lateral bars, proximal to the external surface of the side wall of the upper-level lateral bar. The floor may be inclined towards a container.

Optionally, the open ends of the tough are enclosed. Optionally, the lateral section profile of the lower-level lateral bars is a V-shaped profile or a U-shaped profile having a rounded, to improve the flow of the heat, generated by the heat source, towards the upper-level lateral bars.

Optionally, the heat source is selected from the group including open flames, an electric heater, a burning gas and charcoal briquettes. Optionally, the broiling rack further includes an inclination mechanism, adapted to adjust the inclination angle of the lateral bars towards a selected trough.

Optionally, the inclination mechanism includes one or more rotating shafts each having a pair of cams securely attached thereto, wherein one of the cams is pointing towards a first direction and the other cam is pointing towards the opposite direction. The cams are disposed below one of the lateral bars, wherein each cam is disposed at a location proximal to a different trough. When a first cam is pointing upwards, the one of the lateral bars is inclined towards the trough distal from the first cam, and wherein when the second cam is pointing upwards, the one of the lateral bars is inclined towards the trough distal from the second cam.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a perspective view of a broiling rack for a barbecue grill, according to embodiments of the present invention.

FIGS. 2a, 2b, 2c and 2d are front-section views, illustrating example variations of the lateral bars forming the broiling rack shown in FIG. 1.

FIGS. 3a, 3b and 3c are side-section views, illustrating example variations of the lateral bars forming the broiling rack shown in FIG. 1.

FIG. 4 is a front, partial-section view of a typical configuration of the lateral bars of a portion of a variation of the broiling rack shown in FIG. 1, wherein the upper-level lateral bars and the lower-level lateral bars are embodied as separate units.

FIG. 5 is a front, partial-section view of a typical configuration of the lateral bars of a portion of the broiling rack shown in FIG. 1.

FIG. 6 is a front-section view, illustrating another example of a lateral bar, having a concave bottom surface.

FIG. 7 is a front-section view, illustrating another example of a lateral bar, having a flat bottom surface, wherein a groove is formed at the bottom surface of each lateral bar, proximal to the bottom-most edge of the external surface of the wall of the lateral bar.

FIG. 8 illustrates an example inclination mechanism for inclining the broiling rack shown in FIG. 1, towards a selected trough.

### DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Meanings of technical and scientific terms used herein are to be commonly understood as to which the invention belongs, unless otherwise defined. The present invention can be implemented in the testing or practice with methods and materials equivalent or similar to those described herein.

It should be noted that orientation related descriptions such as “bottom”, “up”, “upper”, “down”, “lower”, “top” and the like, assumes that the associated item is operationally situated.

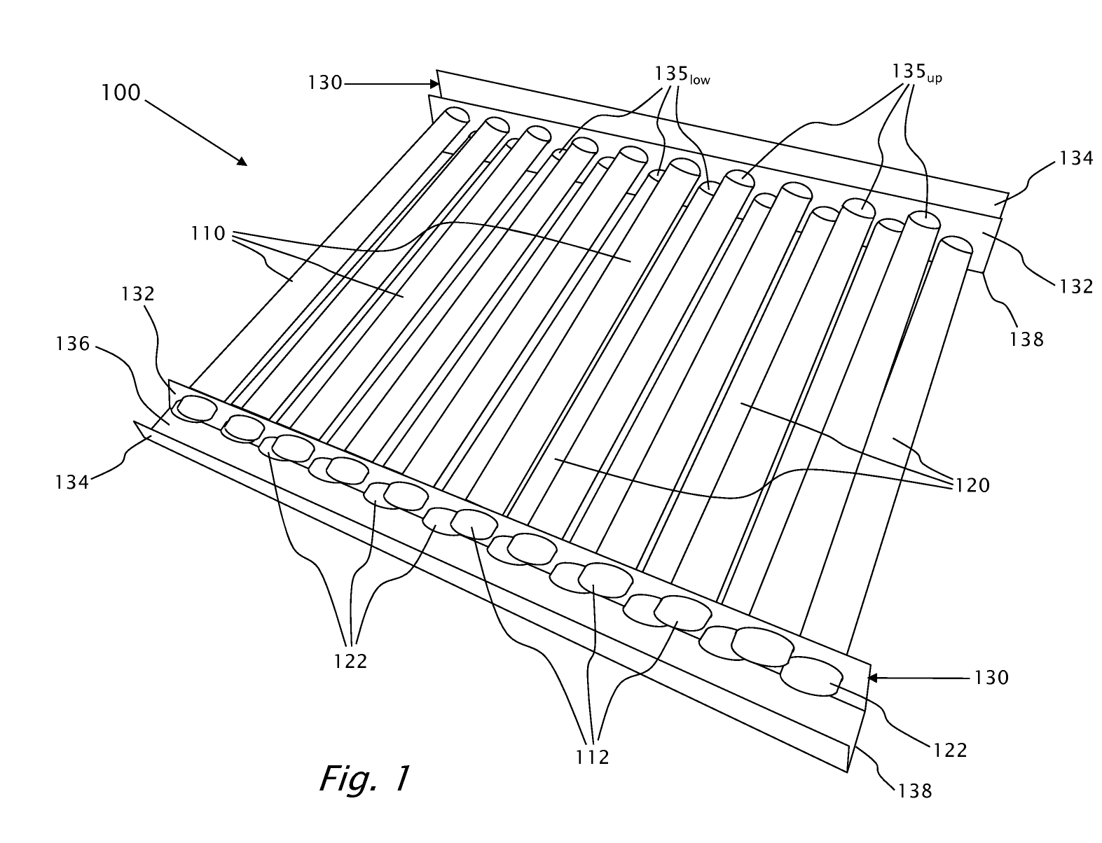

Reference is now made to the drawings. FIG. 1 is a perspective view of a broiling rack 100 for a barbecue grill (not shown), according to embodiments of the present invention. Broiling rack 100 includes two levels of grease collecting lateral bars, an upper-level lateral bar 110 and a lower-level lateral bar 120. A multiplicity of openings 135 are formed in each of side walls two side walls 132; wherein each end of the lateral bars (110, 120) is fittingly inserted through a respective opening of the multiplicity of openings 135, formed therein at preconfigured locations. Each end of the lateral bars (110, 120) is seated in a respective opening 135, wherein optionally, one or both side walls 132 are the inner walls of a trough 130, having a floor 136 and an outer wall 134. Broiling rack 100 may be made of one piece or assembled from two or more parts. The lateral bars (110, 120) are made of materials commonly used for making cooking grid for barbecue grills.

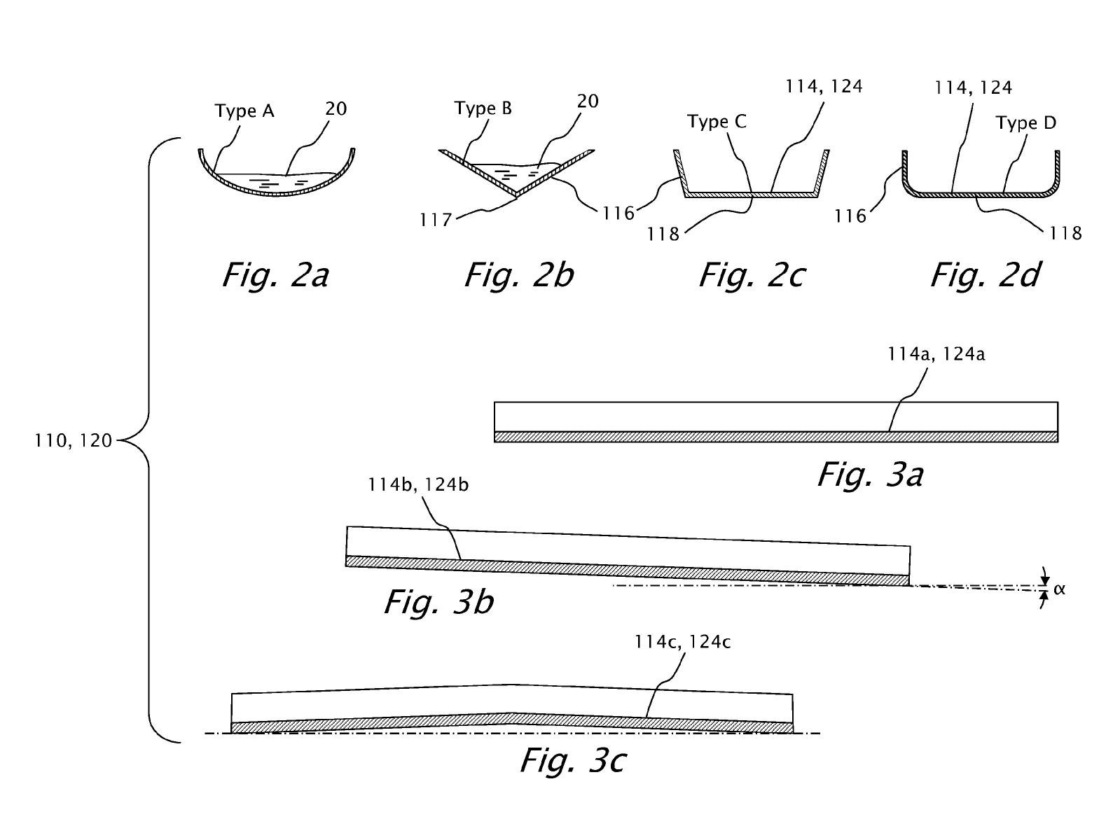

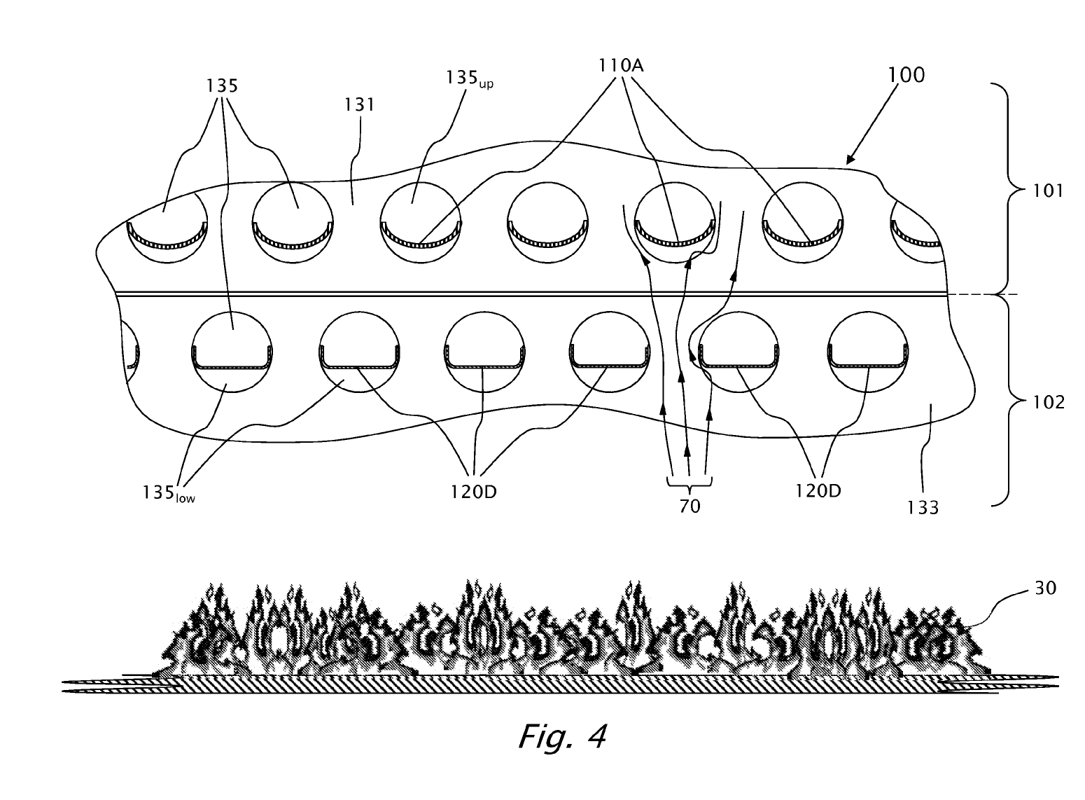

FIGS. 2a, 2b, 2c and 2d are front-section views, illustrating example variations of the lateral bars (110, 120) forming broiling rack 100, having different profiles. The lateral section profile of show a concaved shape of each lateral bar (110, 120) facilitating channeling out the accumulated grease 20 through side walls 132. FIG. 2a shows a type A, U-shaped lateral section profile; FIG. 2b shows a type B, V-shaped lateral section profile; FIG. 2c shows an inverted-trapezoid-shaped lateral section profile of type C; and FIG. 2d shows a type D, U-shaped lateral section profile having a floor that is mostly flat.

FIGS. 3a, 3b and 3c are side-section views, illustrating example variations of the lateral bars (110, 120) forming broiling rack 100. The inner floor surface of the lateral bars (110, 120) may be flat (114a, 124a) or slopped towards one (114b, 124b)), by a preconfigured angle α, or slopped towards both (114c, 124c) troughs 130.

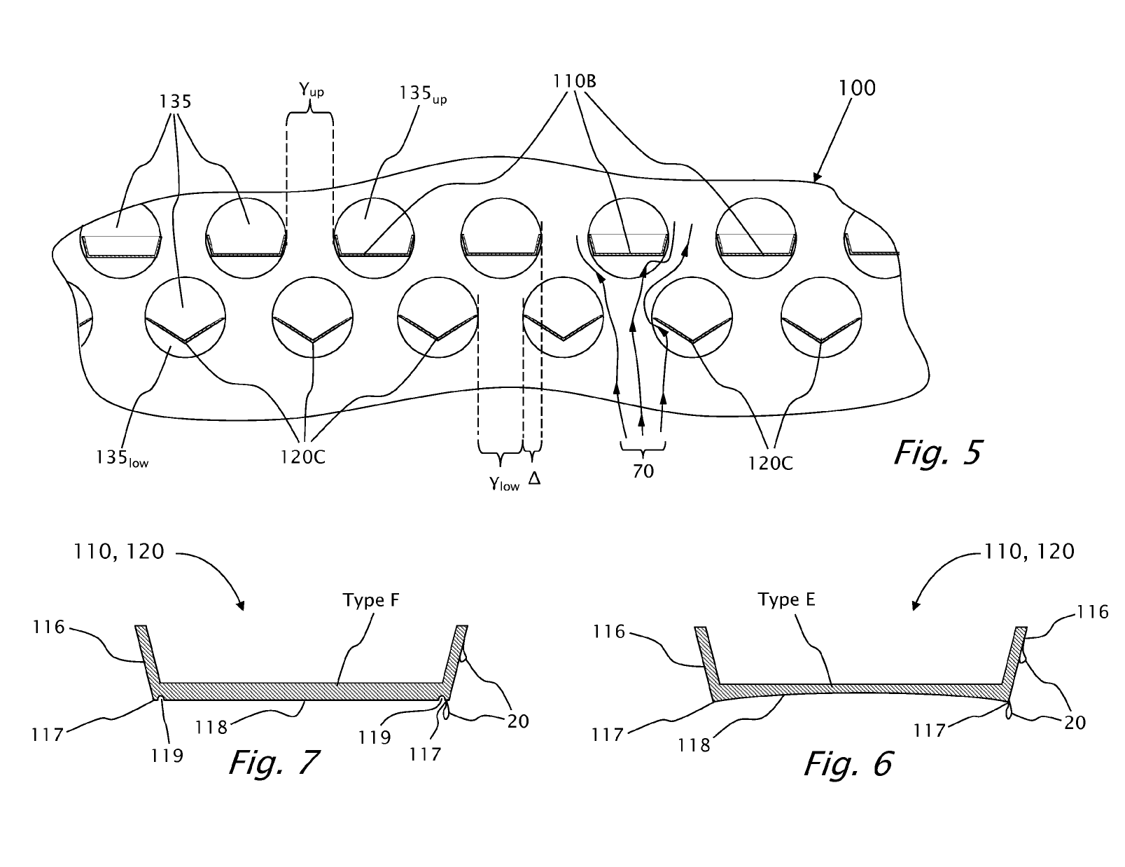

FIG. 5 is a front-section view of a typical configuration of the lateral bars (110, 120) of a portion of broiling rack 100. When viewed from the side of the outer walls 134, each level of lateral bars (110, 120) forms, in general, a spatially horizontal plane.

In this example, with no limitations, upper-level lateral bars 110 have a V-shaped lateral section profile, and lower-level lateral bars 120 have an inverted-trapezoid-shaped lateral section profile. Upper-level bars lateral 110 and lower-level lateral bars 120 are spaced apart to allow free hot air flow to reach the meats (or any other items) disposed on top of upper-level lateral bars 110.

All of the lateral bars (110, 120) are substantially parallel to each other, wherein gaps γᵤₚ are formed between adjacent upper-level lateral bars 110, and gaps γ_{low} are formed between adjacent lower-level lateral bars 120. Gaps γ facilitate heat, generated by heat source 30, to reach items placed on top of upper-level lateral bars 110.

The width of each lower-level lateral bar 120 is wider than the gap γᵤₚ situated directly above the respective upper-level lateral bar 120. In FIG. 5 the overlapping width is annotated by Δ, which overlapping width is annotated by Δ enhances the probability of collecting grease drops 20 that drop from a meat piece, for example, through a gap γᵤₚ.

Operatively, openings 135ᵤₚ of multiplicity of openings 135, formed in each side wall 132, are configured to accommodate upper-level lateral bars 110 and are generally horizontal. Openings 135_{low} of multiplicity of openings 135, formed in each side wall 132, are configured to accommodate lower-level lateral bars 120 and may also be generally horizontal.

From a bird's-eye view, upper-level lateral bars 110 conceal gaps γ_{low} and partially overlap lower-level lateral bars 120, such that for each gap γᵤₚ, a respective lower-level lateral bar 120 is disposed directly below that gap γᵤₚ, and for each gap γ_{low}, a respective upper-level lateral bar 110 is disposed directly above that gap γ_{low}.

It should be noted that upper-level lateral bars 110 are wider than γ_{low} and lower-level lateral bars 120 are wider than γᵤₚ. Hence, collecting grease drops 20 that drop from a meat piece, for example, through a gap γᵤₚ, will drop into the lower-level lateral bar 120, disposed directly below that gap γᵤₚ.

However, there is still the probability that drops of grease 20 will flow downwards along the external surface 116 of a side wall of an upper-level lateral bar 110, for example, in the case of lateral bars 110 having a V-shaped lateral section profile, as shown in FIG. 5. In such a case the drops of grease 20 may flow downwards along the external surface 116 of the side wall of the lateral bar 110 and drop down to heat source 30 from the bottom-most edge 117, where both external surfaces 116 meet.

Reference is now made to FIG. 6, a front-section view, illustrating another example of a lateral bar (110, 120), type E, having a concave bottom surface 118 that is typically used as an upper-level lateral bar 110. When using an upper-level lateral bar (110) having a concave bottom surface 118, drops of grease 20 may flow downwards along the external surface 116 of the side wall of an upper-level lateral bar 110 and drop down towards the respective lower-level lateral bar 120, disposed there below, from the bottom-most edge 117 formed by the external surface 116 and concave bottom surface 118, the upper-level lateral bars 110 being of type E.

Reference is also made to FIG. 7, a front-section view, illustrating another example of a lateral bar (110, 120), type F, that is also typically used as an upper-level lateral bar 110. An upper-level lateral bar 110 of type F, has a groove 119 formed at the bottom surface 118 of each upper-level lateral bar (110), proximal to the bottom-most edge 117 of the external surface 116 of the side wall of the upper-level lateral bar (110). When using an upper-level lateral bar 110 of type F, drops of grease 20 may flow downwards along the external surface 116 of the side wall of an upper-level lateral bar 110. In such a case the drops of grease 20 may flow downwards along the external surface 116 of the side wall of the upper-level lateral bars 110 and drop down to the respective lower-level lateral bar 120, disposed there below, from the bottom-most edge 117, the upper-level lateral bar 110 being of type F.

Referring back to FIG. 1, grease 20 collected by both levels of lateral bars (110, 120) is channeled out through side walls 132, wherein one or both side walls 132 are the inner walls of a trough 130, having a floor 136 and outer wall 134. The end portions (112, 122) of lateral bars (110, 120) are either extending into the space formed between inner walls 132 and outer wall 134, or the ends of end portions (112, 122) of lateral bars (110, 120) are substantially flush with in trough (130) inner surface of inner walls 132. The liquid grease 20 collected by troughs 130 may be contained within troughs 130 by enclosing both ends (138) of each trough 130. Alternatively, the collected grease 20 flows out of troughs 130, through one or both open ends 138, and collected by one or more containers.

It should be noted that using a lateral bar (110, 120) of types such as type A and type B, as a lower-level lateral bar 120, facilitates free flowing of the heat, coming from the source of heating 30, towards the meats, as illustrated, by way of example, in FIG. 5, by hot air flow 70.

It should be further noted that broiling rack 100 also facilitates positioning the broiled item, such as meat, in proximity to the heat source 30. The heat source 30 may be open flames, an electric heater, burning gas, charcoal briquettes or any other heating source.

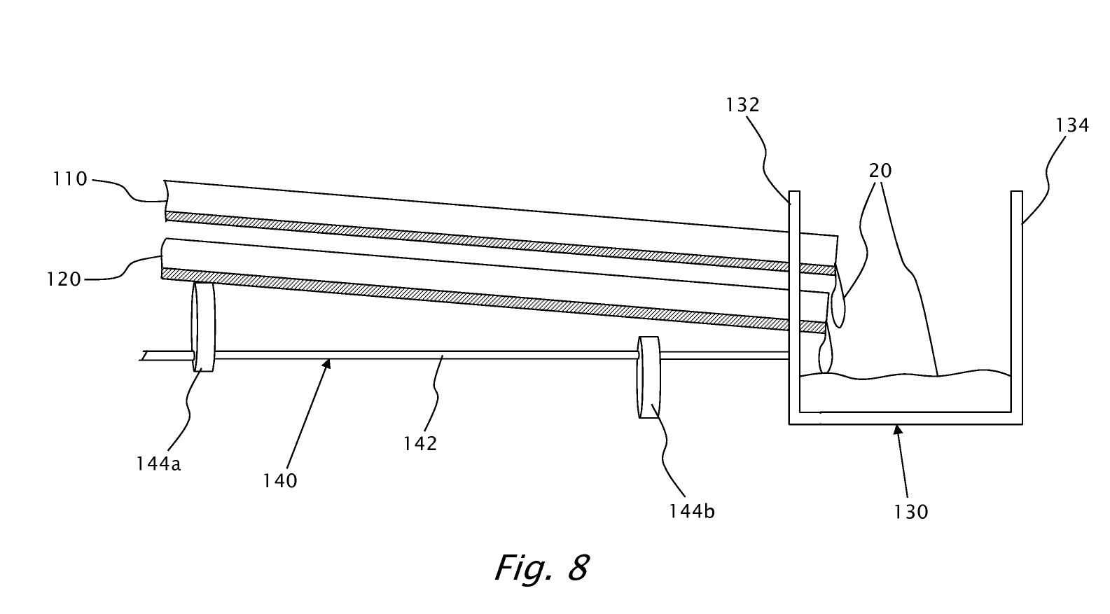

In variations of the present invention, the slopes of one or both lateral bars (110, 120) can be adjusted, such that the liquid grease can flow faster or slower from the lateral bars (110, 120) into a selected trough 130. Reference now is made to FIG. 8, showing an example inclination mechanism 140 for inclining broiling rack 100 towards a selected trough 130. In the example shown in FIG. 8, inclination mechanism 140 includes cams 144 securely mounted on a shaft 142, wherein shaft 142 is pivoted such that a first cam 144a lifts one side of broiling rack 100. In order to lift the second side of broiling rack 100, shaft 142 is pivoted by 180°, with respect to the position shown in FIG. 8. It should be noted that inclination mechanism 140 shown in FIG. 8 is given by way of example only, with no limitations, and any other lifting/inclination mechanism known in the art may be used within the scope of the present invention.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

1-13. (canceled)

14. A broiling rack for draining liquid dripping, comprising:
upper level lateral bars located at a first plane to accumulate the liquid dripping;
lower level lateral bars located at a second plane to accumulate the liquid dripping; and
wherein, in operational position, the upper level lateral bars are spaced apart and situated above the lower level lateral bars,
and wherein the upper level lateral bars are substantially parallel to each other such that gaps γᵤₚ are formed between adjacent upper level lateral bars and the lower level lateral bars are substantially parallel to each other such that gaps γ_{low} are formed between adjacent lower level lateral bars,
and wherein the gaps γᵤₚ are situated directly above the lower level lateral bars,
and wherein the width of each of the lower level lateral bars is wider than gap γᵤₚ.

15. The broiling rack of claim 14, wherein the upper level lateral bars are of a first profile type and the lower level lateral bars are of a second profile type.

16. The broiling rack of claim 14, wherein the width of each of the lower level lateral bars is wider than gap γᵤₚ situated above such that an overlapping width Δ is formed.

17. The broiling rack of claim 14, wherein the gaps γ_{low} are situated directly below the upper level lateral bars,
and wherein the width of each of the upper level lateral bars is wider than gap γ_{low}.

18. The broiling rack of claim 17, wherein the width of each of the upper level lateral bars is wider than gap γ_{low} situated below such that an overlapping width is formed.

19. The broiling rack of claim 14, wherein the upper level lateral bars and the lower level lateral bars are placed to facilitate free flowing of heat from a heat source; wherein, in operational position, the heat source is located below the lower level lateral bars.

20. The broiling rack of claim 14, further comprising:
side walls comprising openings, and wherein each end of the lateral bars is situated in a respective opening.

21. The broiling rack of claim 20, wherein at least one side wall comprises:
an inner wall;
an outer wall; and
a floor,
wherein the openings are in the inner wall and the lateral bars are situated such that a collected liquid dripping flows to a space between the inner wall and the outer wall.

22. The broiling rack of claim 21, wherein the upper level lateral bars and the lower level lateral bars are slopped towards the at least one side wall.

23. The broiling rack of claim 22, wherein slops of the upper level lateral bars and the lower level lateral bars are adjustable.

24. The broiling rack of claim 14, further comprising a heat source; wherein, in operational position, the heat source is located below the lower level lateral bars.

25. The broiling rack of claim 24, wherein the heat source is at least one of an open flame, an electric heater, a burning gas and a charcoal briquettes
